(19) United States
(12) Patent Application Publication
(10) Pub. No.: US 2014/0110911 A1
(43) Pub. Date: Apr. 24, 2014

(54) Tilt Resistant Trash Bin

(71) Applicant: Richard W. O'Connor, Redwood City, CA (US)

(72) Inventor: Richard W. O'Connor, Redwood City, CA (US)

(21) Appl. No.: 14/058,785

(22) Filed: Oct. 21, 2013

Related U.S. Application Data
(60) Provisional application No. 61/716,696, filed on Oct. 22, 2012.

(51) Int. Cl. B65F 1/14

(52) U.S. Cl. CPC B65F 1/141; B65F 1/1473
USPC 280/47.26; 280/755; 29/428

(57) ABSTRACT

A tilt-resisting member for a wheeled trash bin is provided. The tilt-limiting member fits a wheeled trash bin having a bottom, a back, a front, and a center of gravity between the back and front. The wheels represent a first fulcrum with a first distance from the center of gravity and provide a pivot point upon which the trash bin can be tilted back. The back edge of the member comprises a second fulcrum that can operably replace the first fulcrum, the second fulcrum having a distance from the center of gravity that is greater than that of the first fulcrum. The increased distance of the second fulcrum from the center of gravity increases the force required to tilt the center of gravity past the second fulcrum.

### CROSS-REFERENCE TO RELATED APPLICATIONS

This application claims priority to U.S. Provisional Patent Application No. 61/716,696 of O'Connor, entitled “Animal resistant trash bin”, as filed on Oct. 22, 2012, and which is incorporated in its entirety into the present application.

### INCORPORATION BY REFERENCE

All publications and patent applications mentioned in this specification are herein incorporated by reference to the same extent as if each such individual publication or patent application were specifically and individually indicated to be so incorporated by reference.

### TECHNICAL FIELD OF THE INVENTION

This application relates to tilt resistant systems for containing trash. More particularly, the application relates to an improvement for a wheeled trash bin that renders the trash bin tilt-resistant, but which is non-disruptive of the operation of the trash bin in the larger trash collection system.

### BACKGROUND

Wheeled trash bins have been widely integrated into waste collection business systems, such as Waste Management, Inc. and Recology, Inc., merely by way of example. These waste collection business systems can make use of bins that segregate material into categories, such as garden or plant waste, garbage, and material to be recycled. The wheeled bins are robust, low cost, and highly functional in a system wherein a waste collection truck driver can operate a robotic arm that lifts the bin from the ground, empties the contents into a collecting hold, and then replaces the emptied bin on the ground. Two aspects of the wheeled trash bin that are significant for facilitating the operation of the bins in an integrated trash collection system, also create vulnerability of the trash bins to being moved across the surface upon which they are resting, and/or to being tipped over and contents being scattered about either by wind, by animals, or by an unintentional event, such as being hit by a vehicle. These aspects are the wheels, themselves, and a freely openable lid.

The wheeled aspect of the bins is important, as this allows the trash collection customer to easily tip the bin back onto the wheels, and roll it from its usual location to the curb for pick up by a trash collection truck. It is also important that the lid of the bin be freely openable, so that when the bin is lifted and turned upside down over the opening to the trash hold of the truck, the lid falls open and allows the contents of the trash bin to fall into the truck's holding compartment. These two particular features that facilitate the use of the bin in the trash collection system (i.e., the wheels and the freely openable lid) also contribute to the vulnerability of the bin to being tipped over and opened on the street by local animals, such as dogs or raccoons, or by high winds, and the contents of the bin being scattered about.

Embodiments of commercially available wheeled trash bins (see FIG. 1) are elongate and upright; the wheels are positioned at what is considered the back side of the bin, and the lid has a hinged connection and a handle by which to move the bin, as a whole, at the back. The elongate upright profile of the bin generally is one that creates a relatively high center of gravity that contributes to a vulnerability to being tilted to the point of tipping over. A handle that opens the lid, pivoting at the hinges, is located at the front of the lid (and front of the bin). The wheels represent a pivot point or a fulcrum, generally disposed within the profile of the bin, as viewed from above, or at the back edge of the bin. This positioning allows the trash bin user to tip or tilt the bin back on the wheels (with the front end of the bin lifted off the ground), and thereby move the bin easily.

The wheels, however, and also, make it much easier to push the bin backwards (in the direction of the side of the bin on which the wheels are mounted) even without tipping or tilting the bin, as a person moving the bin would normally do. In this scenario, the bin still scrapes along the ground, but there is relatively little friction impeding movement in that backward direction, as compared to the friction encountered in pushing the bin in any other direction. The wheels, thus, make it relatively easy for animals to (1) push the trash bin, and (2) tip the bin over.

Second, the freely opening feature of the lid, as the bin is tipped over, allows the contents of the bin to spill onto the street, and it also allows animals to freely enter the bin. Many types of animal resistant systems rely on a secure lid, but securing the lid in a closed configuration is not compatible with the integrated business system for collecting trash, which requires that the lid be freely openable.

A non-disruptive adaptation applicable to wheeled trash bins that would render them tilt-resistant could be a useful and welcome development in the market.

### SUMMARY OF THE TECHNOLOGY

Several embodiments of the technology are disclosed, all of which stabilize a wheeled trash bin as it sits upright on a support surface, such as a street, sidewalk, floor, the ground, or any site where the trash bin may normally be found. As used herein, a “ground surface” or simply “ground” refers to any support surface. A curb lining a street, for these purposes, may also be referred to as a support surface or a ground surface, even though it is elevated with respect to the street surface. Wheeled trash bins are designed for easy movement when tilted back on their wheels by a user. Stabilization, as referred to in this disclosure does not refer to any compromise of the normal mobility of a trash bin when being handled purposefully by a user. Stabilization on a support surface may refer generally to reducing lateral mobility when the trash bin is simply sitting on the support surface. Stabilization, in this aspect, refers to the trash bin not being easily moved by being pushed, pulled, or knocked about by high wind, by animals, or by any incidental occurrence not intended as a purposeful move by a user. In a related aspect, stabilization may also refer to the trash bin not being easy to tip over on its side, particularly on its backside, by tilting or pivoting over the wheels. Accordingly, stabilization may also be referred to as tilt-resistance; for example, a trash bin may be tilt-resistant, an article of manufacture that bestows tilt-resistance on a trash bin may be referred to as a tilt-resister, or, in some embodiments, as a tilt-resisting member. Stabilization may generally refer to the combined features of the trash bin (1) being resistant to lateral movement across a support surface when the bin is sitting on such support surface and (2) being resistant to being tipped over. Indeed, when wheeled trash bins are knocked over, it comes about commonly by the combined effects of being pushed laterally across a surface, and then being knocked over.

Thus, one set of embodiments of the technology effectively prevent or minimize the likelihood of a wheeled trash bin from being forcibly tipped over, either by accident, by high winds, or by the activity of animals. Tipping forces that can cause the trash bin to tip include a downward force vector on the bin at the back (behind the bin's center of gravity), an upward force vector from a point in front of the center of gravity, a frontally directed force, or any combination of these force vectors. These embodiments can be understood by identifying the wheels of a trash bin as a fulcrum about which a type 1 or type 2 levers can be operated. Downward (stabilizing, anti-tipping) force is provided at the point or line that defines the center of gravity of the trash bin. The tilt-limiting member establishes a second fulcrum, which is a greater distance from the center of gravity than the first fulcrum as provided by the wheels. In a type 1 levering operation, a downward force vector is applied to the trash bin in back of the wheels. In a type 2 levering operation, an upward force vector is applied to the trash bin from a point in front of the center of gravity. By either levering operation, the lengthening of the distance between the center of gravity and the fulcrum provides greater resistance to operation of the lever. Accordingly, in these embodiments, a tilt-limiting member operates to stabilize the wheeled trash bin by shifting the relative position of a fulcrum between a site of applied downward force and the center of gravity. Another anti-tilt factor is at play also, as the tilt-limiter acts as a fulcrum at a higher level on the bin than do the wheels. In some embodiments, the tilt-limiting member assembly can be added to an otherwise conventional wheeled trash bin. In other embodiments, a tilt-resisting member can be included as part of the initial fabrication of a tilt-resistant wheeled trash bin.

An alternative set of embodiments operates by intervening in the operation of the wheeled trash bin at the level of the wheels, more particularly at the rotatable aspect of the wheels as the wheels function as a fulcrum. The rotatable aspect of the wheels, as described in the Background section, although convenient for handling the trash bin, also represent a vulnerability that increases unwanted mobility, and increases risk of the trash bin tipping over. Accordingly, in these alternative embodiments, stabilizing features are included in the wheeled trash bin that render the rotatable aspect of the fulcrum non-rotatable. In some embodiments, the wheels are directly rendered non-rotatable. In other embodiments, a second and non-rotatable fulcrum is brought into play that functionally replaces the wheels in their role as a fulcrum.

Accordingly, in some embodiments of the technology, a tilt-resister applicable to a wheeled trash bin includes an elongate, substantially flat tilt-limiting member, the tilt-resisting member having an anchor portion with a trash bin axle fixation site, and a ground-contacting shelf portion having a bottom edge. The tilt-resisting member is configured to be compatible with a wheeled trash bin, the trash bin having: a bottom wall, a back wall, a front wall, and a center of gravity disposed between the back wall and the front wall, and a set of wheels on an axle positioned proximate a junction of the bottom wall and the back wall. The wheels of the trash bin provide a first tilting fulcrum at a first distance from the bin's center of gravity. The tilt-resisting member is configured such that when the tilt-resisting member is installed on the trash bin and the trash bin is positioned upright on a ground surface, the ground-contacting shelf provides a second tilting fulcrum at a second distance from the trash bin's center of gravity that is greater than the first distance from the center of gravity.

In such embodiments, if the wheeled trash bin is tilted back such that the center of gravity moves past the first fulcrum, the ground-contacting shelf is configured to contact the ground surface underlying or adjacent to the wheeled trash bin, thereby engaging the ground-contacting shelf as a second fulcrum, the force required to tilt the trash bin over the second fulcrum being greater than that required to tilt the trash bin over the first fulcrum.

In some embodiments, the ground contacting-shelf is configured such that when the trash bin is stably positioned on a ground surface, the bottom edge of the ground-contacting shelf is positioned at an elevation above the ground. With regard to this elevation, in typical embodiments, the elevation above the ground surface is sufficient to allow the trash bin to be tilted such that the trash bin is mobile on the set of wheels. In some embodiments, the elevation above the ground surface is at least as high as a street curb such that the trash bin can be placed with its wheel set flush against the street curb. In some embodiments, the tilt-resisting member is configured such that the elevation of the ground-contacting shelf above the ground surface is adjustable.

In various embodiments, the tilt-resisting member may further include one or more ancillary fixation sites appropriate for attaching it to a wheeled trash bin. In some embodiments, the tilt-resisting member is left or right sided, and may included one or more side-specific features that make member appropriately configured for either a left side or a right side of a wheeled trash bin. And in some embodiments, the tilt-resisting member may be packaged to include fixation elements suitable for fixing the tilt-resisting member to the trash bin. In some embodiments, the tilt-resisting member(s), fixation elements, and an instructional sheet or brochure detailing how to attach the tilt-resisting member(s) to a wheeled trash bin may be provided as a kit.

Some embodiments of the technology take the form of a wheeled trash bin that has tilt-resisting assembly built in or integrated into the bin as it emerges from fabrication. Accordingly, in these embodiments, the wheeled trash bin includes a bottom wall, two side walls, a back wall, a front wall, and a center of gravity positioned between the back wall and the front wall, and a set of wheels on an axle positioned proximate a junction of the bottom wall and the back wall, wherein the wheels provide a first tilting fulcrum at a first distance from the center of gravity. Such embodiment further includes at least one tilt-resisting member fixed to the axle of the trash bin, the member including an anchor portion having a trash bin axle fixation site, and a ground-contacting shelf including a bottom edge, wherein a distance between the axle-fixation site and the ground-contacting shelf marks a second distance from the center of gravity, the second distance from the center of gravity being greater than the first distance from the center of gravity.

In embodiments such as these, where the wheeled trash bin is factory assembled to include a tilt-resisting member, aspects of any one or more of the bottom wall, the side walls, or the bottom walls of the trash bin may be configured or molded so as to be particularly compatible with the at least one tilt-resisting member. Similarly, the tilt-resisting member may be configured so as to be particularly compatible with the wheeled trash bin into which it is being incorporated.

Embodiments of the technology also include methods of assembling a tilt-resistant wheeled trash bin. Briefly these methods include providing a wheeled trash bin and a tilt resistant member that are mutually compatible, and then installing the tilt-resisting member on the wheeled trash bin. Installing typically includes mounting the tilt-resisting member on the axel of the trash bin and applying any optional fixation elements to the bin. Such a wheeled trash bin and such a tilt-resisting member are summarized and described herein. Embodiments of the tilt-resisting member may be provided in a package or kit that further includes fastening elements and instructions. Instructions may take the form of a sheet of paper, a brochure, and include either or both written and pictorial instructions. Such instructions may also be provided by way the Internet.

Embodiments of the technology also include methods of preventing a tip over of a wheeled trash bin, or at least resisting a tip over, or minimizing the ease with which a wheeled trash bin can be tipped over. Some embodiments of the method include providing a wheeled trash bin, the trash bin having a bottom wall, a back wall, a front wall, and a center of gravity positioned between the back wall and the front wall, and a set of wheels on an axle positioned proximate a junction of the bottom wall and the back wall, wherein the wheels include a first tilting fulcrum at a first distance from the center of gravity. The trash bin further includes at least one tilt-resisting member fixed to the axle of the trash bin, the member including an anchor portion having a trash bin axle fixation site, and a ground-contacting shelf having a bottom edge, wherein when the trash bin is positioned upright on a ground surface, a distance between the axle-fixation site and the ground-contacting shelf marks a second distance from the center of gravity, the second distance from the center of gravity being greater than the first distance from the center of gravity. The method of preventing or resisting a tip over further includes tilting the trash bin back over the first fulcrum with a level of force sufficient to tilt the bin to a point wherein the center of gravity goes past the first fulcrum; and engaging the second fulcrum against the ground surface, such engagement thereby increasing the level of force required to tilt the trash bin over.

The technology further includes alternative embodiments, wherein a wheeled trash bin can be stabilized on a support surface by reversibly rendering the wheels non-rotatable. Accordingly, these embodiments of a wheeled trash bin of include a bottom wall, a back wall, a front wall, and a center of gravity positioned between the back wall and the front wall, and a set of wheels on an axle positioned proximate a junction of the bottom wall and the back wall. The wheels of the trash bin provide a rotatable first tilting fulcrum at a first distance from the trash bin's center of gravity. The wheeled trash bin of this embodiment further includes at least one rotatable fulcrum rotational neutralizing mechanism, the mechanism being configured to be movable between a position of non-engagement with the rotatable fulcrum that allows the rotatable fulcrum to rotate freely and a position of engagement that disallows rotation of the rotatable fulcrum.

In particular embodiments such as these, when the rotatable fulcrum rotational neutralizing mechanism is engaged, such engagement creates a second fulcrum, such fulcrum at a second distance from the trash bin's center of gravity that is greater than the first distance from the center of gravity.

Embodiments of the technology further include methods of resisting movement of wheeled trash bin across a support surface. The method includes providing an embodiment wheeled trash bin, as summarized above, particularly including the at least one rotatable fulcrum rotational neutralizing mechanism. The method then includes engaging the rotatable fulcrum rotational neutralizing mechanism, such engagement thereby resisting, impeding, or preventing the rotatable fulcrum from rotating.

Some alternative embodiments of the technology include a mechanism that has the capability of reversibly rendering the rotatable wheels inoperable as a fulcrum. Accordingly, these alternative embodiments of a wheeled trash bin include a bottom wall, a back wall, a front wall, and a center of gravity positioned centrally between the back wall and the front wall, and a set of wheels positioned at a junction of the bottom wall and the back wall, the set of wheels providing a rotatable first fulcrum positioned at a junction of the bottom wall, said fulcrum being rotatable. Such embodiments further include a non-rotatable second fulcrum extendable rearward from the trash bin, the second fulcrum configured to be reversibly positionable between engagement with a ground surface upon which the trash bin is resting and non-engagement with said ground surface. When the non-rotatable second fulcrum is engaged with the ground surface, the engagement creates sufficient frictional contact with the ground surface that movement of the bin that would otherwise be facilitated by the rotatable first fulcrum is at least impeded.

In such embodiments, the rotatable first fulcrum is at a first distance from the trash bin's center of gravity, and the non-rotatable second fulcrum, when it engages the ground surface, is positioned at a greater distance from the center of gravity of the trash bin than is the rotatable first fulcrum.

Embodiments of the technology further include methods of resisting movement of wheeled trash bin across a support surface and resisting a tip over, in accordance with an alternative embodiment having a non-rotatable second fulcrum, as summarized above. This second fulcrum is configured to be reversibly positionable between engagement with a support surface upon which the trash bin is resting and non-engagement with said support surface, and when the non-rotatable second fulcrum is engaged with the support surface, the engagement creates sufficient frictional contact with the support surface that movement of the bin that would otherwise be facilitated by the rotatable first fulcrum is inoperable. This embodiment of the method then includes positioning the non-rotatable second fulcrum such that it engages the support surface.

In such embodiments, when the non-rotatable second fulcrum is positioned such that when the second fulcrum engages the support surface it is positioned at a greater distance from the center of gravity as the rotatable first fulcrum, the method may further include resisting an amount of tip over force that would otherwise tip over the trash bin.

### BRIEF DESCRIPTION OF THE FIGURES

FIG. 1 shows various force vectors that may incidentally be directed toward a wheeled trash bin, ultimately causing it to tip over backwards, over the wheels.

FIGS. 2A-2B show a tilt-resisting member in a side view (FIG. 2A) and end view (FIG. 2B) that is appropriate for mounting on a wheeled trash bin, in one embodiment.

FIGS. 3A-3B show a tilt-resisting member in a perspective views of the inner side (FIG. 3A) and the external side (FIG. 3B) that is appropriate for mounting on a wheeled trash bin, in one embodiment.

FIG. 4 shows a back perspective view of a wheeled trash bin with a tilt-resisting member mounted thereon over the axle, in one embodiment.

FIGS. 5A-5C show various views of a wheeled trash bin with a tilt-resisting member mounted thereon, in one embodiment. FIG. 5A shows a front view; FIG. 5B shows a side view; and FIG. 5C shows a side view with a detailed view of an adjustment mechanism that has raised the level of a ground-contacting shelf.

FIG. 6 shows a back perspective view of a wheeled trash bin with a built in tilt-resisting member, in one embodiment.

FIG. 7 shows a back perspective view of a wheeled trash bin with a built in wheel brake, in one embodiment.

FIGS. 8A-8D show various views of a wheeled trash bin with a wheel brake, in one embodiment; FIG. 8A is a front view, FIG. 8B is a side view with the brake in an engaged position, FIG. 8C is a side view with the brake in an off position.

FIG. 9 shows a back perspective view of a wheeled trash bin with a non-rotatable second fulcrum mechanism installed thereon, in one embodiment.

FIGS. 10A-10C show various views of a wheeled trash bin with a non-rotatable second fulcrum mechanism thereon, in one embodiment; FIG. 10A is a front view, FIG. 10B is a side view with the non-rotatable second fulcrum mechanism in an engaged position, FIG. 10 is a side view with non-rotatable second fulcrum mechanism in an off position.

### DETAILED DESCRIPTION OF THE TECHNOLOGY

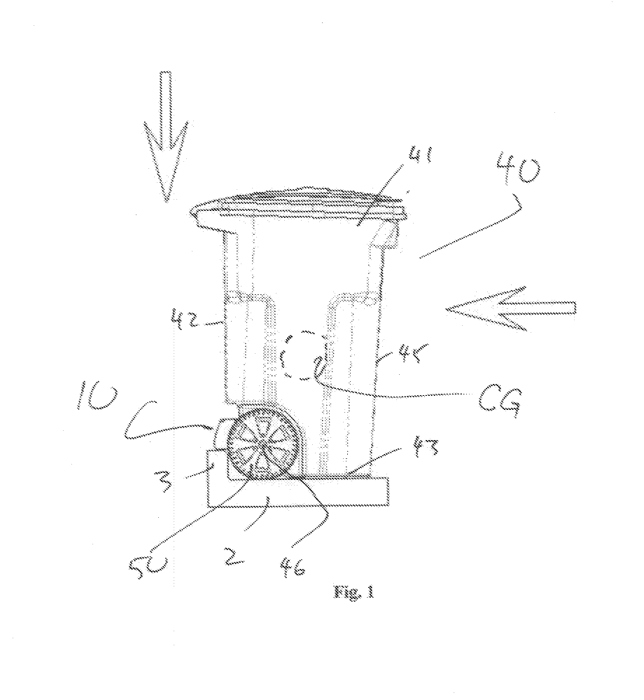

FIG. 1 shows various force vectors that may incidentally be directed toward a wheeled trash bin, ultimately causing it to tip over backwards, over the wheels. Wheeled trash bin embodiment 10 is resting on a ground support surface 2, and is back up against a street curb 3 at an elevation above the ground surface. Basic elements of trash bin 10 include a top 41, a backside 42, bottom portion 43, front side 45, and lateral (left and right) sides 44. A set of wheels 50 is disposed at the back end of the bottom of the trash bin, proximate the junction of the backside 42 and bottom side 43. Wheels 50 are disposed on an axle 46, and the back portion of a tilt-resisting member 10 is seen projecting back from the wheels, and resting on curb surface 3. Arrows represent force vectors that can impinge on the wheeled trash bin. A center of gravity (CG) is shown in an approximately central location within the bin; the specific location will vary according to particulars of the trash bin construction and the distribution of trash within the trash bin. One such vector is directed at the front of the trash bin, which urge the bin to move backward or tip over. Another vector is directed downward at the rear of the trash bin, which also urges the trash bin to tip over backward.

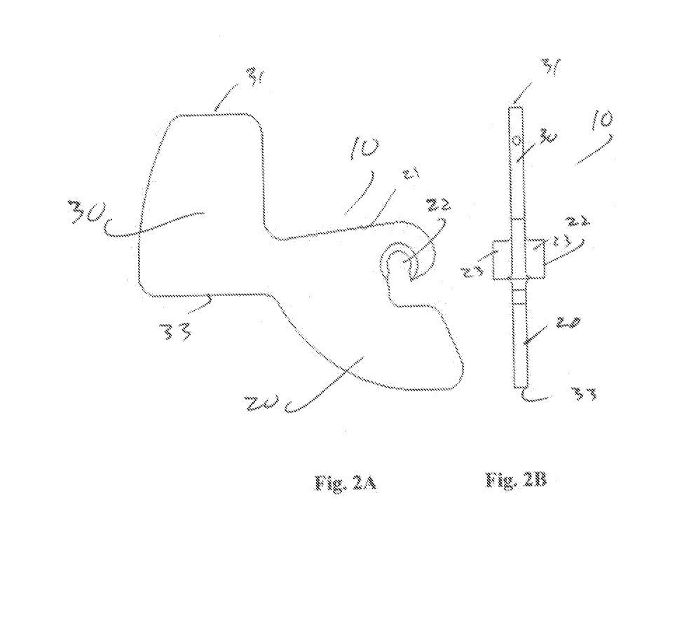

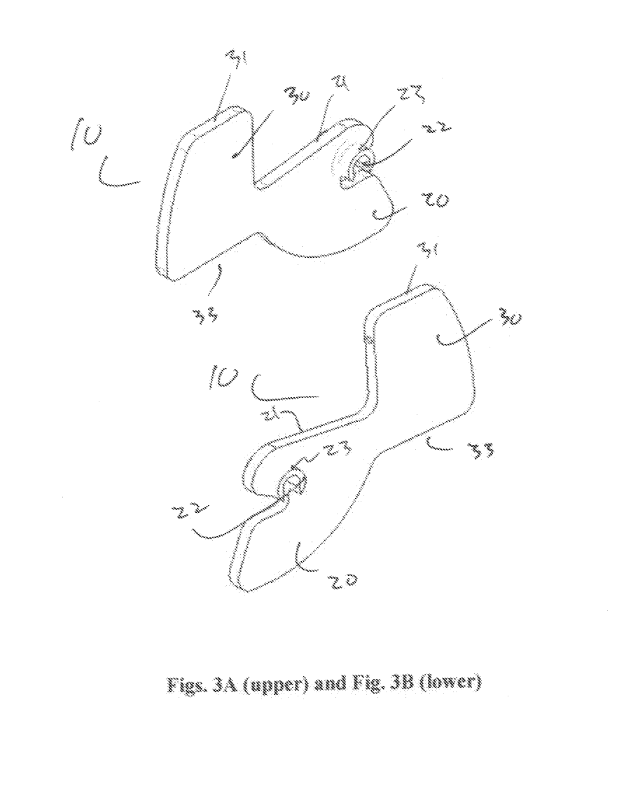

FIGS. 2A-2B show a tilt-resisting member 10 in a side view (FIG. 2A) and end view (FIG. 2B) that is appropriate for mounting on a wheeled trash bin, in one embodiment. FIGS. 3A-3B show a tilt-resisting member 30 in a perspective views of the inner side (FIG. 3A) and the external side (FIG. 3B). Embodiments of tilt-resisting member 10 include an anchoring portion 20 and a ground-contacting shelf portion 30. Anchoring portion 20 and ground-contacting portion 30 are commonly integrated as a whole, but may be separate portions joined together. Anchoring portion 20 includes a hole that fits around an axle of the wheeled trash bin, which also may include flange elements 23 that stabilize the anchoring portion on the axle. Anchoring portion 30 also includes an upper edge 21. Ground-contacting portion 30 includes a top edge 31 and a lower edge 33, the lower edge contacting the ground when the tilt-resisting member is positioned against a ground support surface or against a curb.

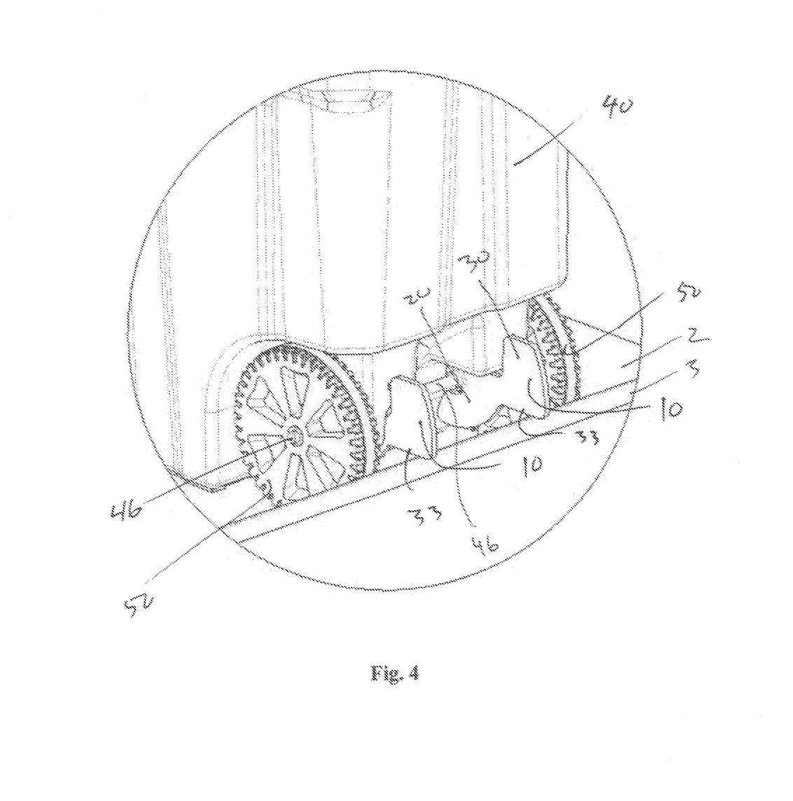

FIG. 4 shows a back perspective view of a wheeled trash bin 40 with a tilt-resisting member 10 mounted thereon over the axle, in one embodiment. The trash bin is resting on ground surface 2; the trash bin is shown to be abutting curb 3, with the tilt-resisting member 10, the lower edge 33 thereof in particular, resting on top of curb 3. In such a position, tilt-resisting member 10 is positioned so as to resist tipping forces as depicted by arrows in FIG. 1. Also seen in FIG. 4 is axle 46, upon which wheels 50 and tilt-resisting member 10 are all mounted.

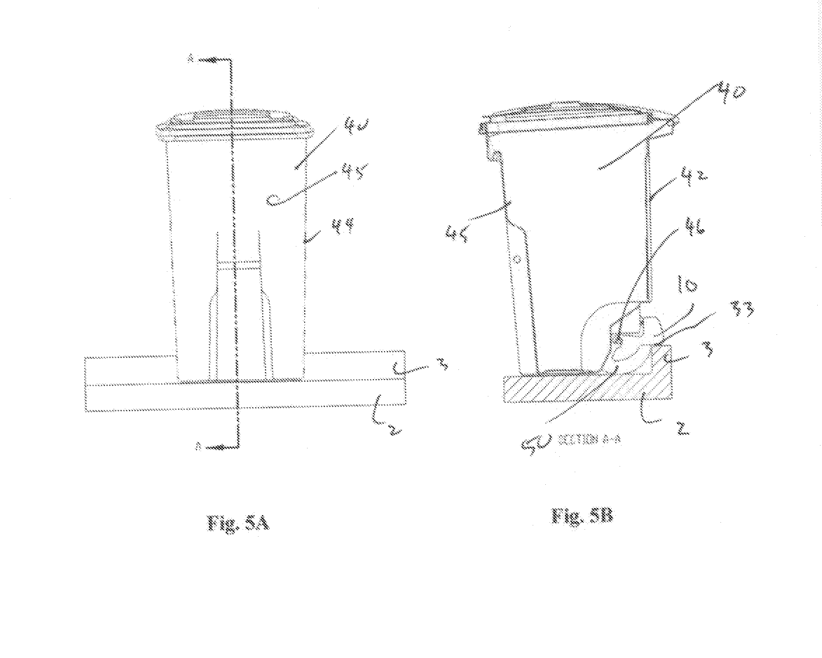

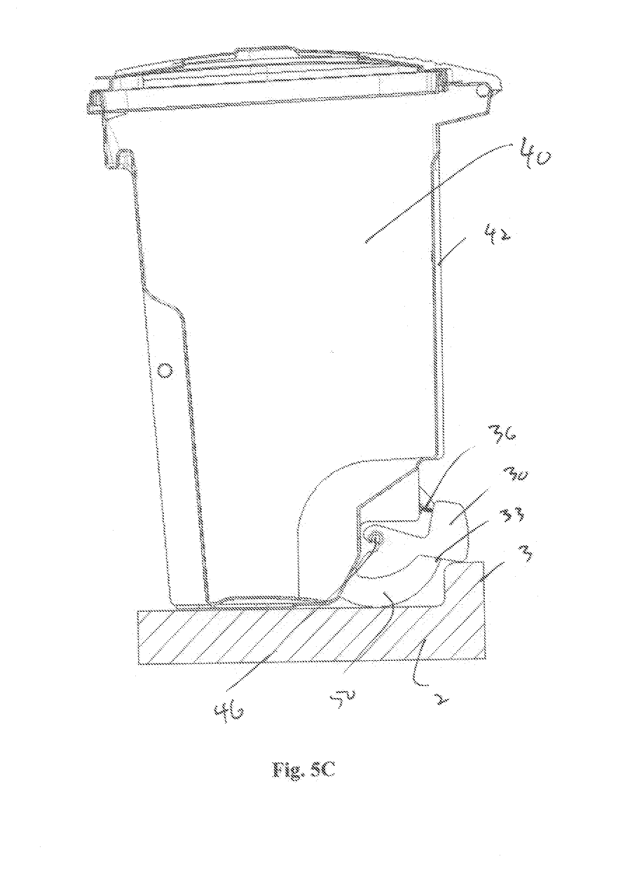

FIGS. 5A-5C show various views of a wheeled trash bin 40 with a tilt-resisting member mounted 30 thereon, in one embodiment. FIG. 5A shows a front view; FIG. 5B shows a side view; and FIG. 5C shows a side view with a detailed view of an adjustment mechanism 36 that has raised the level of a ground-contacting shelf portion 30 of tilt-resisting member 10. FIG. 5C affords the best view of an example of an adjustment mechanism 36. The tilt-resisting member 30 of this embodiment can rotate around axle 46 within a narrow arc, for example an arc of approximately 20 degrees, merely by way of example. A curb 3 can vary in height or elevation above a ground or street surface 2; accordingly it is advantageous to be able to adjust the angle of tilt-resisting member 30 such that the elevation of the bottom edge 33 of the ground-contacting portion can be appropriately adjusted. One or more adjustable attachments 36 to the body of the trash bin can fix the angle such that it is appropriate for a particular curb. Such an adjustment mechanism can be of any suitable form, a turnbuckle being but one example.

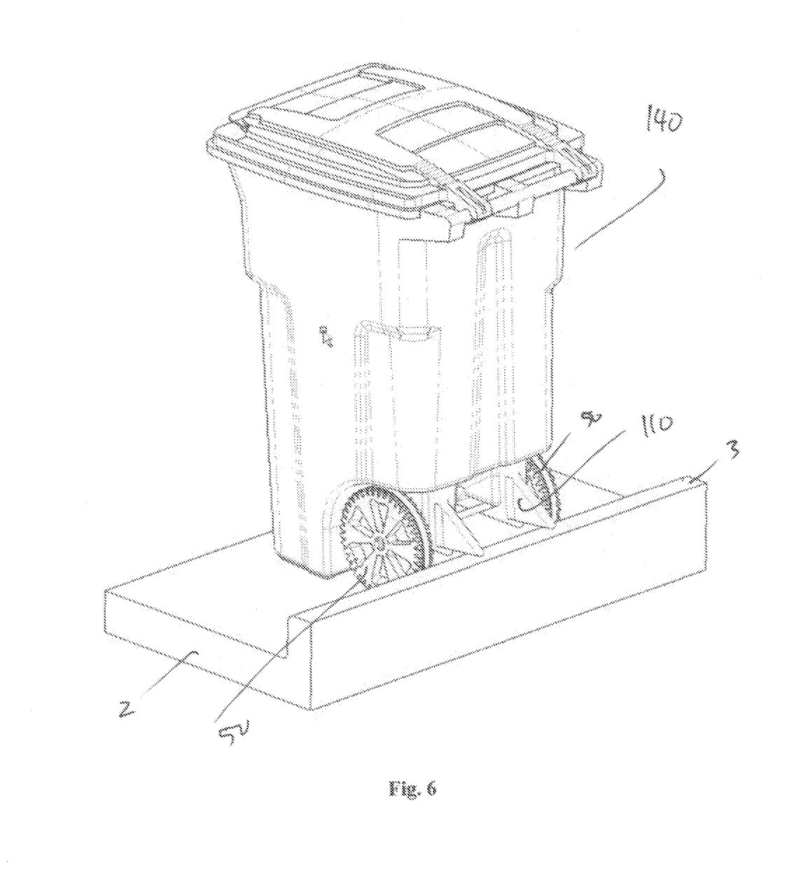

FIG. 6 shows a back perspective view of a wheeled trash bin 140 with a built in tilt-resisting member 110, in one embodiment. Aspects of trash bin 140 that make it suitable for hosting a built-in tilt-resisting member may include molded features or attachment sites that are arranged to provide a host site for the tilt-resisting member 110. Further, the tilt-resisting member may be sized and configured to particularly fit such molded features or attachment sites on the trash bin. Other than having the built-in tilt-resisting member, other aspects of wheeled trash bin 140 may be substantially the same as the features of wheeled trash bin 40, as depicted in FIGS. 1, 4, and 5A-5C. Additionally, in further related embodiments, the wheeled trash bin 140 and built in tilt-resisting member 110 may include features that permit adjustability of the elevation of the tilt-limiting member above a ground support surface 2 or curb 3.

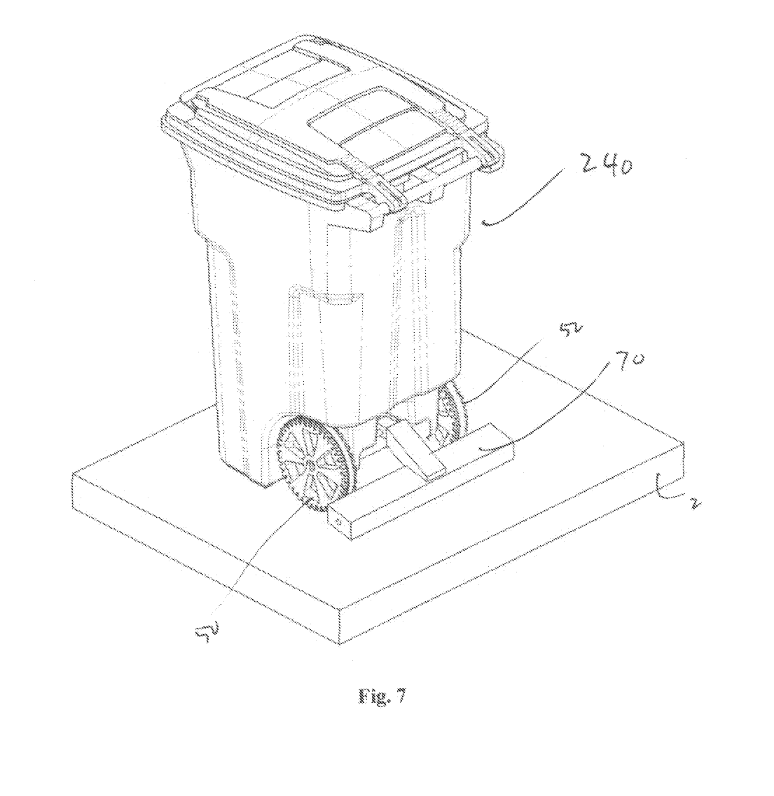

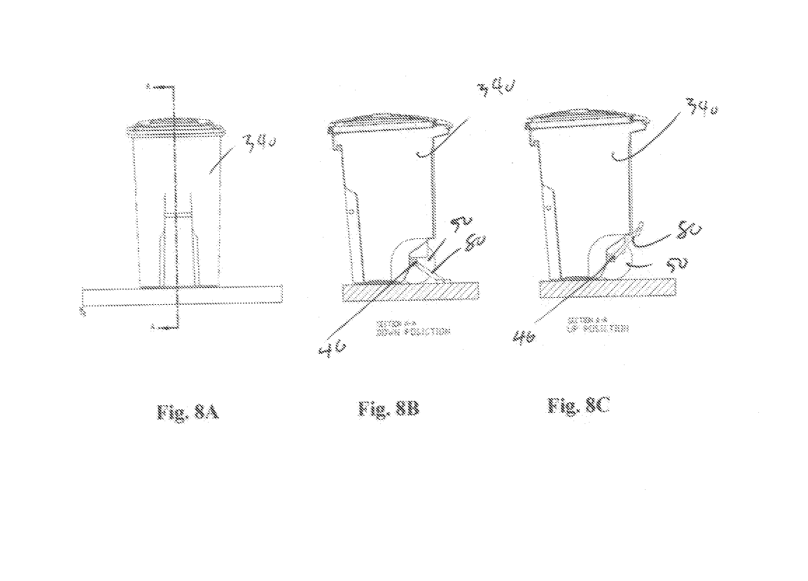

FIG. 7 shows a back perspective view of an embodiment of wheeled trash bin 240 with a built in wheel brake 70. FIGS. 8A-8B show various views of a wheeled trash bin with a wheel brake, in one embodiment; FIG. 8A is a front view, FIG. 8B is a side view with the brake in an engaged position, FIG. 8C is a side view with the brake in an off position.

Aspects of trash bin 240 that make it suitable for hosting a built-in tilt-resisting member may include, merely by way of example, molded features or attachment sites that are arranged to provide a host site for the built in wheel brake 70. Further, the tilt-resisting member may be sized and configured to particularly fit such molded features or attachment sites on the trash bin. Other than having the built-in tilt-resisting member, other aspects of wheeled trash bin 240 may be substantially the same as the features of wheeled trash bin 40, as depicted in FIGS. 1, 4, and 5A-5C. Additionally, in further related embodiments, the wheeled trash bin 240 with built-in wheel brake 70 may include features that permit adjustability of the elevation of the tilt-limiting member above a ground support surface 2 or curb 3.

Wheel brake 70, as shown, is but one example of many suitable arrangements for a brake. Typically, brake embodiments can be adjusted between an on position (when the brake engages the wheels and prevents wheels from turning) and an off position (which allows the wheels to move freely). FIG. 7 shows brake 70 in an on position, as it contacts the ground surface and contacts the edge surface of wheels 50 at the same time. FIGS. 8B and 8C show side views of the brake 70 in an on position and an off position, respectively.

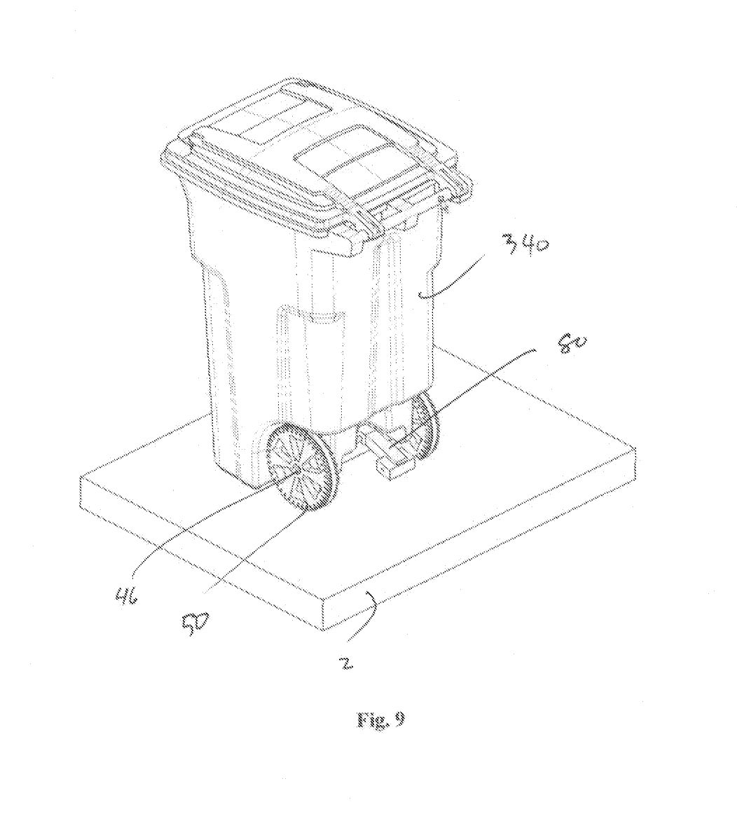

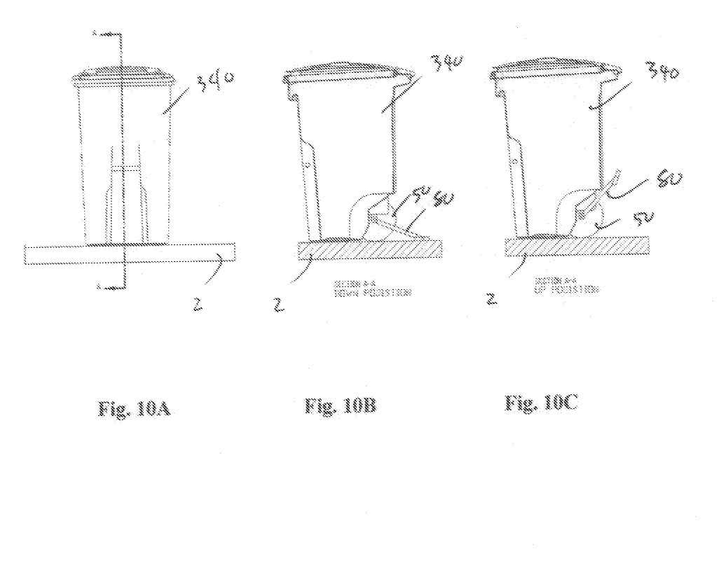

FIG. 9 shows a back perspective view of an embodiment of a wheeled trash bin 340 with a non-rotatable second fulcrum mechanism 80 installed thereon. FIGS. 10A-10C show various views of wheeled trash bin 340 with a non-rotatable second fulcrum mechanism thereon; FIG. 10A is a front view, FIG. 10B is a side view with the non-rotatable second fulcrum mechanism in an engaged position, FIG. 10C is a side view with non-rotatable second fulcrum mechanism in an off position.

Aspects of trash bin 340 that make it suitable for hosting a built-in tilt-resisting member may include, merely by way of example, molded features or attachment sites that are arranged to provide a host site for the non-rotatable second fulcrum mechanism 80. Further, non-rotatable second fulcrum mechanism 80 and configured to particularly fit such molded features or attachment sites on the trash bin. Other than having non-rotatable second fulcrum mechanism 80, other aspects of wheeled trash bin 340 may be substantially the same as the features of wheeled trash bin 40, as depicted in FIGS. 1, 4, and 5A-5C. Additionally, in further related embodiments, the wheeled trash bin 340 and built in tilt-resisting member 110 may include features that permit adjustability of the elevation of the tilt-resisting member above a ground support surface 2.

Non-rotatable second fulcrum mechanism 80 as shown, is but one example of many suitable arrangements for such a mechanism. Typically, a Non-rotatable second fulcrum mechanism can be adjusted between an on position (when the non-rotatable fulcrum contacts the ground) and an off position (when the non-rotatable fulcrum is not contacting the ground, thereby allowing the wheeled trash bin to move freely on its wheels). FIG. 9 shows the non-rotatable fulcrum 80 in an on position, as it contacts the ground surface. FIGS. 10B and 10C show side views of the non-rotatable fulcrum 80 in an on position and an off position, respectively.

### EXAMPLE OF AN EMBODIMENT

A trash bin tilt-resister or pivot-limiter prevents or decreases the ease with which a trash bin can be turned over by raccoons or other animals, and does not interfere with a homeowner being able to easily roll the can to the street and the collection truck to lift and empty the bin using the robotic arm. This tilt-resisting feature accommodates different street curb heights and is operable in the absence of a curb. The basic function is to keep the center of pivot of the trash can at the wheel axis which permits easy mobility but to limit how far the bin can be rotated back either when against a curb or with no curb. A tilt-resisting member may be fabricated from molded or die cut piece metal, wood, ruggedized plastic such as ABS or PC that may include glass fill to increase structural strength of the element, or any suitable material or any combination of suitable materials.

The tilt-resisting member may be mounted on the axis of the wheels or on the body of the bin. Mounting the tilt-resisting member on the axle provides a means to attach it either thru a press fit over the axle or an assembled over the axle or disassembly of the axle and through hole-mount over the axle. Use of specified holes that correlate to curb height would allow the user/installer to insert a pivot limiters into the frame as appropriate for local conditions.

For example, if the curb is 8 inches in height, then two pins on the tilt-resisting member may be installed that correspond to an 8-inch curb spacing. These pins mate against the outside of the can thereby keeping the can from tilting beyond the needed limit. If a homeowner is not placing the trash bin against a street curb, then a lower height such as, by way of example, about 3-4 inches keeps the center of gravity from moving past a pivot point, as represented by the wheels of the bin. When the bin's center of gravity moves past the pivot center, the can is much easier to tilt all the way as very little mass or force is required. The tilt-resisting member allows the center of gravity to move past pivot center easily for mobility but limits the pivot angle to just past it. It is a pivot limit or stop point. The tilt-resisting member requires no modification to the trash bin itself and is an easily added accessory thereby leveraging the large installed base. Further, a snap on aspect of this tilt-resister requires no change in behavior of the homeowner or the collection company once installed. The installation time for a tilt-resisting member should be less than about 4 minutes per bin, and would be rugged enough to work for the life of the bin.

What is claimed is:

1. A tilt-resister applicable to a wheeled trash bin comprising:
an elongate, substantially flat tilt-resisting member, the tilt-resisting member comprising an anchor portion comprising a trash bin axle fixation site; and a ground-contacting shelf portion, wherein the tilt-resisting member is configured to be compatible with a wheeled trash bin, the trash bin comprising: a bottom wall, a back wall, a front wall, and a center of gravity disposed between the back wall and the front wall, and a set of wheels on an axle positioned proximate a junction of the bottom wall and the back wall, wherein the wheels of the trash bin comprise a first tilting fulcrum at a first distance from the trash bin's center of gravity, and
wherein the tilt-resisting member, when installed on the trash bin and the trash bin is positioned upright on a ground surface, the ground-contacting shelf comprises a second tilting fulcrum at a second distance from the trash bin's center of gravity that is greater than the first distance from the center of gravity.

2. The tilt-resisting member of claim 1, wherein the ground-contacting shelf is sized and configured to contact the ground surface underlying the wheeled trash bin when the trash bin is tilted back such that the center of gravity moves past the first fulcrum, thereby engaging the ground-contacting shelf as a second fulcrum, the force required to tilt the trash bin over the second fulcrum is greater than that required to tilt the trash bin over the first fulcrum.

3. The tilt-resisting member of claim 1, wherein the ground contacting-shelf is configured such that when the trash bin is stably positioned on a ground surface, the bottom edge of the ground-contacting shelf is positioned at an elevation above the ground.

4. The tilt-resisting member of claim 3, the bottom edge of the ground-contacting shelf is positioned at an elevation above the ground that corresponds to the elevation of a curb proximate the ground support surface.

5. The tilt-resisting member of claim 3, wherein the elevation above the ground surface is sufficient to allow the trash bin to be tilted such that the trash bin is mobile on the set of wheels.

6. The tilt-resisting member of claim 3, the elevation above the ground surface is at least as high as a street curb such that the trash bin can be placed with its wheel set flush against the street curb.

7. The tilt-resisting member of claim 3, wherein the tilt-resisting member is configured such that the elevation of the ground-contacting shelf above the ground surface is adjustable.

8. The tilt-resisting member of claim 1, further comprising one or more ancillary wheeled trash bin fixation sites.

9. The tilt-resisting member of claim 1, wherein the member is left or right sided, comprising
one or more side-specific features that make member appropriately configured for either a left side or a right side of a wheeled trash bin.

10. The tilt-resister of claim 1, further comprising fixation elements suitable for fixing the tilt-resisting member to the trash bin.

11. The tilt-resister of claim 1, wherein the tilt-resisting member is packaged as a kit, the kit further comprising fixation elements suitable for fixing the tilt-limiting member to the trash bin, and instructions as to how to mount the tilt-resisting member to a conventional wheeled trash bin.

12. A tilt-resistant trash bin comprising:
a bottom wall, a back wall, a front wall, two side walls, and a center of gravity positioned between the back wall and the front wall, and
a set of wheels on an axle positioned proximate a junction of the bottom wall and the back wall, wherein the wheels comprise a first tilting fulcrum at a first distance from the center of gravity, and
at least one tilt-resisting member fixed to the axle of the trash bin, the member comprising
an anchor portion comprising a trash bin axle fixation site, and a ground-contacting shelf comprising a bottom edge, wherein a distance between the axle-fixation site and the ground-contacting shelf comprises a second distance from the center of gravity, the second distance from the center of gravity being greater than the first distance from the center of gravity.

13. The tilt-resistant wheeled trash bin of claim 12, wherein aspects of anyone or more of the bottom wall, the side walls, or the bottom walls of the trash bin are configured to be compatible with the at least one tilt-resisting member.

14. A method of assembling a tilt-resistant wheeled trash bin comprising:
providing a wheeled trash bin comprising a bottom wall, a back wall, a front wall, and a center of gravity positioned between the back wall and the front wall, and a set of wheels on an axle positioned proximate a junction of the bottom wall and the back wall, wherein the wheels comprise a first tilting fulcrum at a first distance from the center of gravity;
providing at least one tilt-resisting member fixable to the axle of the trash bin, the member comprising an anchor portion comprising a trash bin axle fixation site, and a groundcontacting shelf comprising a bottom edge, wherein a distance between the axle-fixation site and the ground-contacting shelf comprises a second distance from the center of gravity, the second distance from the center of gravity being greater than the first distance from the center of gravity; and installing the tilt-resisting member on the wheeled trash bin.

15. A tilt-resistant trash bin comprising:
a bottom wall, a back wall, a front wall, and a center of gravity positioned between the back wall and the front wall, and a set of wheels on an axle positioned proximate a junction of the bottom wall and the back wall, wherein the wheels of the trash bin comprise a rotatable first tilting fulcrum at a first distance from the trash bin's center of gravity;
at least one rotatable fulcrum rotational neutralizing mechanism, said mechanism configured to be movable between a position of non-engagement with the rotatable fulcrum that allows the rotatable fulcrum to rotate freely and a position of engagement that disallows rotation of the rotatable fulcrum.

16. The rotatable fulcrum rotational neutralizing mechanism of claim 15, wherein when the rotational neutralizing mechanism is engaged, such engagement creates a second fulcrum, such fulcrum at a second distance from the trash bin's center of gravity that is greater than the first distance from the center of gravity.

17. A tilt-resistant trash bin comprising:
a bottom wall, a back wall, a front wall, and a center of gravity positioned centrally between the back wall and the front wall;
a set of wheels positioned at a junction of the bottom wall and the back wall, the set of wheels comprising a rotatable first fulcrum positioned at a junction of the bottom wall, said fulcrum being rotatable; and
a non-rotatable second fulcrum extendable rearward from the trash bin, the second fulcrum configured to be reversibly positionable between engagement with a ground surface upon which the trash bin is resting and non-engagement with said ground surface,
wherein, when the non-rotatable second fulcrum is engaged with the ground surface, the engagement creates sufficient frictional contact with the ground surface that movement of the bin that would otherwise be facilitated by the rotatable first fulcrum is at least impeded.

18. The tilt-resistant trash bin of claim 17, wherein the rotatable first fulcrum is at a first distance from the trash bin's center of gravity, and wherein the non-rotatable second fulcrum, when positioned such that it engages the ground surface, is positioned at a greater distance from the center of gravity of the trash bin than is the rotatable first fulcrum.
